(19) United States
(12) Patent Application Publication
(10) Pub. No.: US 2019/0167041 A1
(43) Pub. Date: Jun. 6, 2019

(54) FOOD PROCESSING MACHINE AND ASSOCIATED BOWL AND DRIVE ARRANGEMENT

(71) Applicant: ILLINOIS TOOL WORKS INC., Glenview, IL (US)

(72) Inventors: Ruben T. Huerta-Ochoa, Troy, OH (US); Zachary A. Borts, Dayton, OH (US); Curtis A. Smith, New Carlisle, OH (US)

(21) Appl. No.: 16/207,322

(22) Filed: Dec. 3, 2018

Related U.S. Application Data
(60) Provisional application No. 62/595,126, filed on Dec. 6, 2017.

(51) Int. Cl. A47J 43/07; A47J 43/046

(52) U.S. Cl. CPC A47J 43/0716; A47J 43/0727; A47J 43/046

(57) ABSTRACT

A food processing machine includes a mixer body including a stand and a bowl support. A bowl is mounted atop the bowl support, the bowl including a bottom wall with an opening therein, the bowl having an upper edge, wherein a bowl height is defined by a linear distance from the opening to a height of the upper edge. A tubular member is formed separate from the bowl and is connected to the bowl, the tubular member extending upward from the opening and within the bowl, the tubular member including a lower end and an upper end, wherein a tube height is defined by a linear distance from the opening to a height of the upper end of the tubular member, wherein the tube height is less than the bowl height. A drive is mounted below the bowl support.

### TECHNICAL FIELD

This application relates generally to commercial food processing machines commonly utilized for mixing and cutting food products, and more particularly to a bowl and drive arrangement for a mixer-cutter type food processing machine.

### BACKGROUND

Existing commercial food processing machines include a drive motor, a transmission, a food processing tool, a shaft, a bowl, and a dynamic seal. The motor is mounted underneath the bowl, and the motor shaft passes upward through an opening in the bottom of the bowl. To prevent leakage of water or fluids or other material during food processing, a dynamic seal is used to seal against the motor shaft. In particular, a dynamic seal is associated with the opening in the bottom of the bowl and includes a radially inward facing seal portion that contacts the radially outward facing surface of the drive shaft. The dynamic seal may be restrained in place by the mixing tool, but can be removed.

Dynamic seals are more prone to wear than stationary seals, and dynamic seals can be damaged by debris, chemicals, and thermal cycling. The dynamic seals can also be misplaced (or not replaced) by the operator during or after sanitation cleaning of the food processing machine. Dynamic seals are thus more sensitive to variations in operator training and proficiency. Such issues can lead to undesired water or fluid leakage downward through the bottom opening of the bowl toward the drive system.

It would be desirable to provide a commercial food processing machine that eliminates the need for a dynamic seal.

### SUMMARY

In one aspect, a food processing machine includes a mixer body including a stand and a bowl support pivotally mounted on the stand for selective pivot about a horizontal axis. A bowl is mounted atop the bowl support for pivot with the bowl support, the bowl includes a bottom wall with an opening therein, the bowl having an upper edge, wherein a bowl height is defined by a linear distance from the opening to a height of the upper edge. A tubular member is fixed to the bowl and extends upward from the opening and within the bowl. The tubular member includes a lower end and an upper end, the lower end in a stationary sealed arrangement with the bottom wall of the bowl, the stationary sealed arrangement extending around the opening, wherein a tube height is defined by a linear distance from the opening to a height of the upper end of the tubular member, wherein the tube height is least thirty percent of the bowl height. A drive is mounted below the bowl support for pivot with the bowl support. The drive includes a rotatable drive shaft extending upward through the opening of the bottom wall of the bowl and upward through the tubular member. The rotatable drive shaft includes an upper end, wherein a drive shaft height is defined by a linear distance from the opening to a height of the upper end, wherein the drive shaft height is greater than the tube height and less than the bowl height.

In another aspect, a food processing machine includes a mixer body including a stand and a bowl support. A bowl is mounted atop the bowl support, the bowl including a bottom wall with an opening therein, the bowl having an upper edge, wherein a bowl height is defined by a linear distance from the opening to a height of the upper edge. A tubular member is fixed to the bowl and extending upward from the opening and within the bowl, the tubular member including a lower end and an upper end, wherein a tube height is defined by a linear distance from the opening to a height of the upper end of tubular member, wherein the tube height is less than the bowl height. A drive is mounted below the bowl support, the drive including a rotatable drive shaft extending upward through the opening of the bottom wall of the bowl and upward through the tubular member, the rotatable drive shaft including an upper end, wherein a drive shaft height is defined by a linear distance from the opening to a height of the upper end, wherein the drive shaft height is greater than the tube height and less than the bowl height.

In another aspect, a food processing machine includes a mixer body including a stand and a bowl support pivotally mounted on the stand for selective pivot about a horizontal axis. A bowl is mounted atop the bowl support for pivot with the bowl support, the bowl including a bottom wall with an opening therein. A tubular member is connected to the bowl and extending upward from the opening and within the bowl, the tubular member including a lower end and an upper end, the lower end in a stationary sealed arrangement with the bottom wall of the bowl, the stationary sealed arrangement extending around the opening. A drive is mounted below the bowl support for pivot with the bowl support, the drive including a rotatable food processing component drive shaft extending upward through the opening of the bottom wall of the bowl and upward through the tubular member, wherein the rotatable food processing component drive shaft includes an upper end that is above an upper end of the tubular member.

In a further aspect, a food processing machine includes a mixer body including a stand and a bowl support. A bowl is mounted atop the bowl support, the bowl including a bottom wall with an opening therein, the bowl having an upper edge, wherein a bowl height is defined by a linear distance from the opening to a height of the upper edge. A tubular member is formed separate from the bowl and is connected to the bowl, the tubular member extending upward from the opening and within the bowl, the tubular member including a lower end and an upper end, wherein a tube height is defined by a linear distance from the opening to a height of the upper end of tubular member, wherein the tube height is less than the bowl height. A drive is mounted below the bowl support, the drive including a rotatable drive shaft extending upward through the opening of the bottom wall of the bowl and upward through the tubular member, the rotatable drive shaft including an upper end, wherein a drive shaft height is defined by a linear distance from the opening to a height of the upper end, wherein the drive shaft height is greater than the tube height and less than the bowl height.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of a food processing machine;

FIG. 2 is a front elevation of the food processing machine;

FIG. 3 is partial cross-section showing an in bowl drive arrangement of the food processing machine; and

FIGS. 4 and 5 are cross-sections showing an alternative embodiment of an in-bowl drive arrangement.

### DETAILED DESCRIPTION

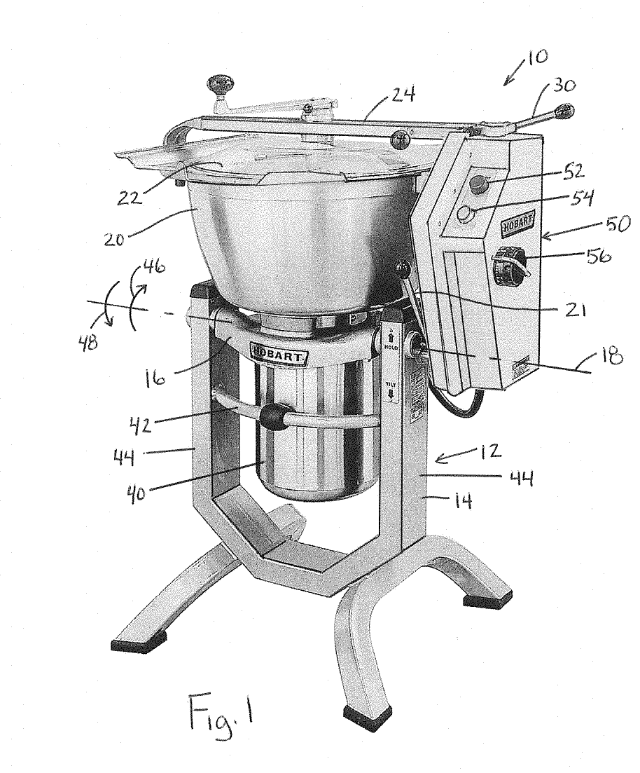

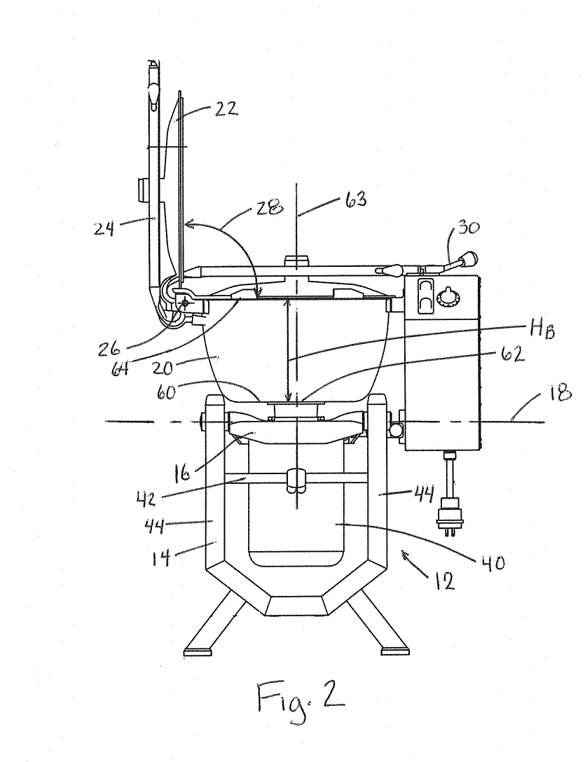

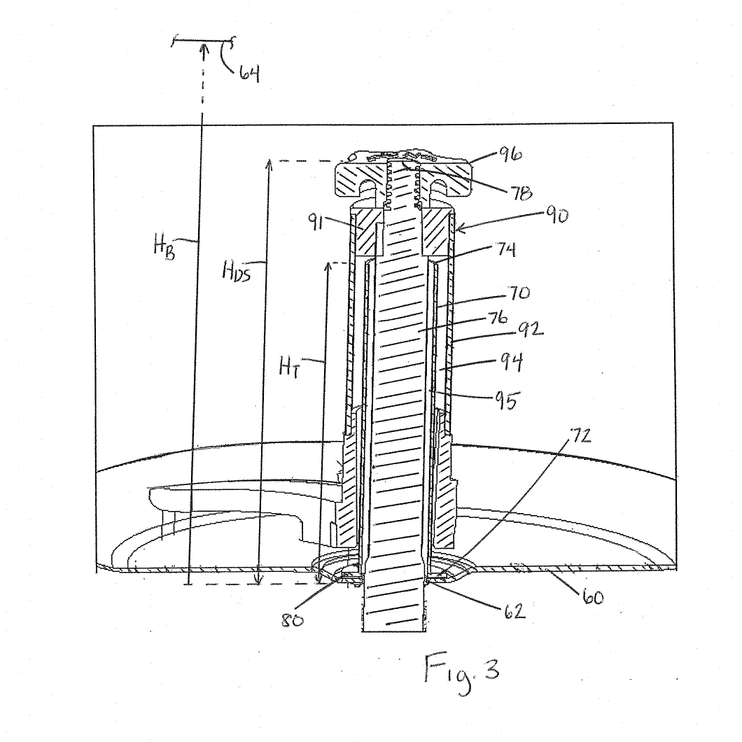

Referring to FIGS. 1-3, a food processing machine 10 includes a mixer body 12 with a stand or frame 14 to which a bowl support 16 is pivotally mounted for selective pivot about a horizontal axis 18. A bowl 20 is mounted atop the bowl support 16 for pivot with the bowl support, and a bowl tilt lever 21 facilitates tilting of the bowl support and bowl. The bowl typically remains in a fixed position on the bowl support during use and cleaning operations. A see through bowl cover 22 is mounted to a pivot arm 24 that is pivotable about a horizontal axis 26 enabling the cover to move from a lowered bowl covering position to a raised bowl access position per movement path 28 in FIG. 2. Both the lowered and raised positions of the arm 24 and cover 22 are shown in FIG. 2 for illustration purposes. A latch member 30 can be engaged with the distal end of the pivot arm 24 when the pivot arm is in the lowered position in order to secure and hold the cover in place during food processing operations.

A drive 40 (e.g., motor or motor and transmission) is mounted below the bowl support 16 and is connected to the bowl support so as to pivot with the bowl support. A limit bar 42 extends between two opposed uprights 44 of the stand 14, and the drive 40 abuts the limit bar 42 when the bowl support, bowl and drive are in an upright working position. The limit bar 42 prevents pivot of the bowl support, bowl and drive out of the upright position in one pivot direction 46, while permitting pivot of the bowl support out of the upright position in an opposite direction 48.

A control box 50 is provided with associated start switch 52, stop switch 54, and timer control 56, which may enable jog, run and timed settings for the machine.

The bowl 20 includes a bottom wall 60 with a central opening 62 therein that aligns with the axis of a drive shaft 76 that extends upward through the opening. Here, the opening 62 is located in a slight downward depression of the bowl bottom wall. The bowl has an upper edge or rim 64, which may or may not include a pouring lip. A bowl depth or height H_{B} is defined by a linear distance from the opening 62 to a height of the upper edge 64. A tubular member 70 is removably connected to the bottom wall of the bowl and extends upward from the opening 62 and within the bowl. The tubular member includes a lower end 72 and an upper end 74, with the lower end 72 in a stationary sealed arrangement with the bottom wall 60 of the bowl. The stationary sealed arrangement extends around the bottom wall opening 62. A tube height H_{T} is defined by a linear distance from the opening 62 to a height of the upper end 74 of tubular member.

A rotatable drive shaft 76 extends upward from the drive 40 through the bottom wall opening 62 and upward through the tubular member 70. The rotatable drive shaft 76 includes an upper end 78, and a drive shaft height H_{DS} is defined by a linear distance from the opening 62 to a height of the upper end 78. As shown, the drive shaft height H_{DS} is greater than the tube height H_{T} and less than the bowl height H_{B}. Thus, the top of the drive shaft 76 extends above the top of the tube 70. By way of example, the tube height H_{T} may be at least thirty percent (e.g., at least forty percent, at least fifty percent, at least sixty percent or at least seventy percent) of the bowl height H_{B}.

Here, the tubular member 70 includes a bottom flange 80 that is held stationarily adjacent the inner surface of the bottom wall 62 about the periphery of the opening 62 for the purpose of sealing. The flange 80 may directly contact the surface of bottom wall 60 for sealing, or a stationary annular sealing gasket may be sandwiched between the flange 80 and the bowl bottom wall 60. The connection between the tubular member and the bowl bottom wall may be via a fastening system (e.g., threaded studs at the bottom of flange 80 extending down through corresponding stud openings in the bowl bottom wall, with nuts at the underside of the bowl connected to the studs), but other variations are possible.

A food processing attachment 90 can be engaged on the upper end 78 of the tubular member, with the food processing attachment including a tubular wall 92 that extends downward alongside, but spaced from, an outer surface of the tubular member 70. In order for fluid or other material within the bowl to reach the opening 62 in the bottom wall 60, the fluid must pass upward along a gap 94 between the inner surface of the tubular wall 92 and the outer surface of the tubular member 70, and then downward through along a gap 95 between the tubular member 70 and the drive shaft 76. This arrangement creates a circuitous path that will limit leakage. Moreover, with proper sizing of the height of the tubular member 70, the upper end or edge of the tubular member will be maintained above a normal height of material within the bowl.

As shown, an upper end 78 of the drive shaft 76 is threaded. The food processing attachment 90 is disposed over the upper end of the drive shaft with the upper end 78 of the drive shaft extending above a top of the food processing attachment. The upper part 91 of the food processing attachment may be keyed to the upper end of the shaft for rotation with the shaft. A handle member 96 is threadedly engaged to the upper end 78 of the drive shaft to retain the food processing attachment on the drive shaft 76. The handle member 96 can be unthreaded and removed to permit removal and replacement of the food processing attachment (e.g., for cleaning or where different types of attachments are provided).

The subject stationary sealed arrangement provided above reduces failure and misplacement issues associated with prior dynamic seals. The arrangement also facilitates cleaning by enabling the food processing tool to be removed and taken to a sink, while at the same time the bowl can be cleaned (e.g., liquid in the bowl but below the top of the tubular member) without the liquid passing through the bottom opening of the bowl.

It is to be clearly understood that the above description is intended by way of illustration and example only, is not intended to be taken by way of limitation, and that other changes and modifications are possible. For example, in alternative embodiments, a bottom portion of the tubular member may threadedly engage with a corresponding threaded portion of the bowl bottom to provide removability, or the tubular member 70 may twist fit/lock to the bottom wall of the bowl for removability or a bottom portion (e.g., the flange) of the tubular member may be welded to the bowl bottom wall (although the removable variations are preferred).

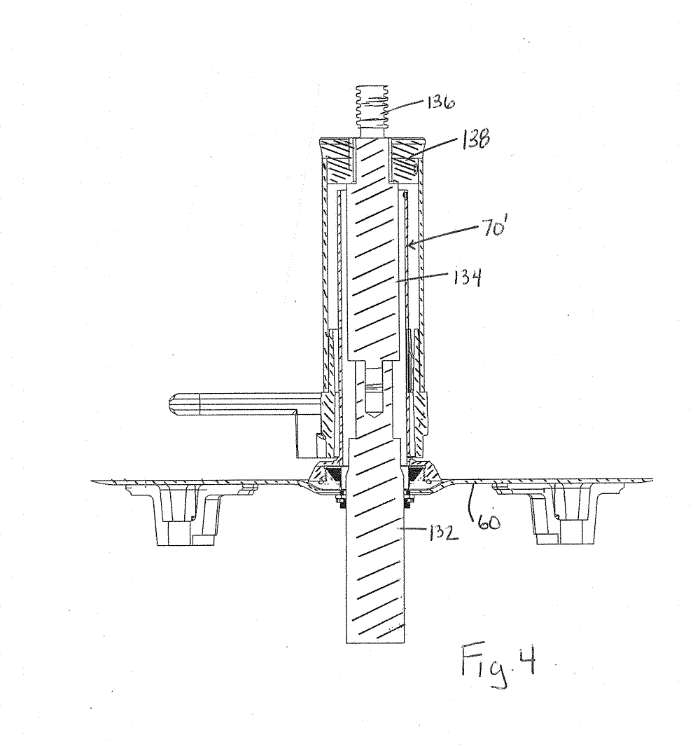

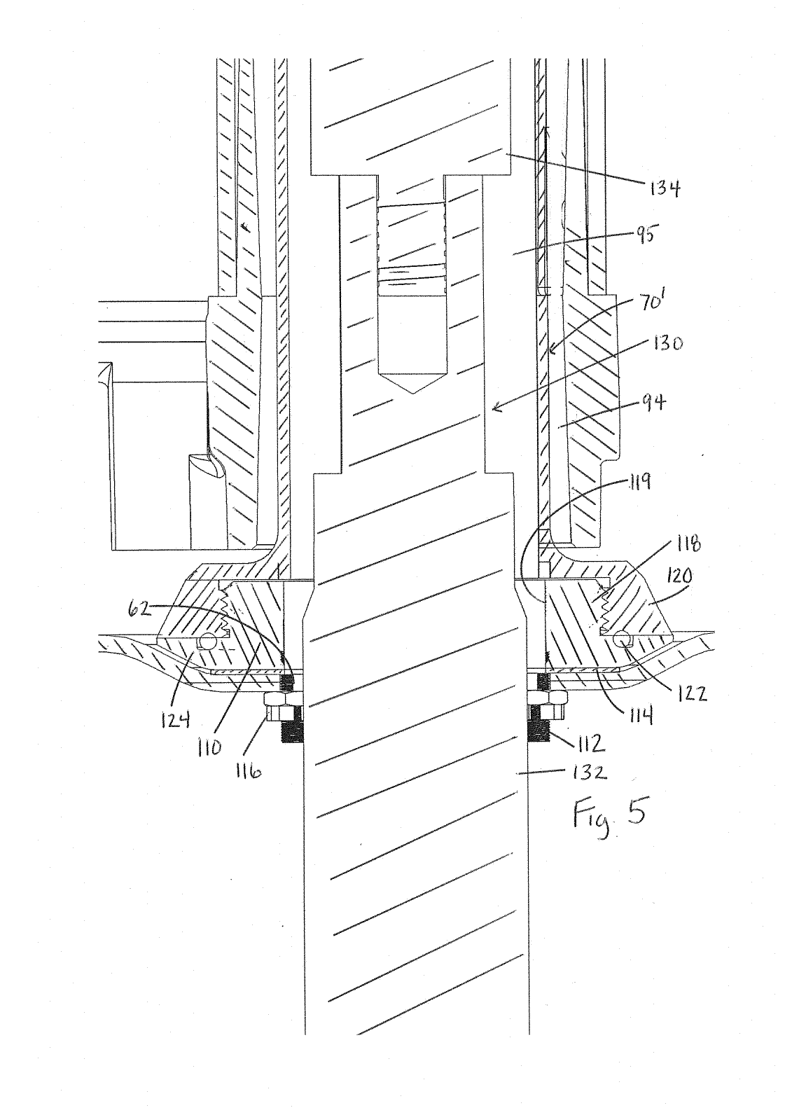

FIGS. 4 and 5 show an exemplary embodiment in which the bottom portion of the tubular member 70′ threadedly engages with a corresponding threaded portion of the bowl bottom. Here, the threaded engagement is with a mount hub 110 that is mounted to the bowl bottom wall 60 by studs 112 that extend downward from the mount hub, through openings in an annular sealing gasket 114 and then through openings in the bottom wall 60. The studs 112 are threaded at least below the bottom wall 60 so that nuts 116 can be used to secure the mount hub 110 in place with a downward pressure against the sealing gasket 114. The mount hub 110 may, for example, be of metal (e.g., stainless steel) and the sealing gasket 114 may, for example, be a nitrile gasket. An upper section 118 of the mount hub is externally threaded and the tube 70′ includes a lower tube mount 120 that is internally threaded to so that the tube 70′ threads onto the mount hub, with an O-ring 122 provided therebetween for sealing. Here, the O-ring 122 is positioned within an annular recess of a lower section 124 of the mount hub, but protrudes upward beyond the top of the recess to assure sealing contact with a downwardly facing surface portion of the tube mount 120. In this embodiment, the drive shaft 130 is in the form of a two-piece drive shaft that includes a lower section 132 and an upper section 134. The lower section extends from the drive and passes upward through the bowl bottom wall opening 62 and a central opening 119 in the mount hub 118, then upward through the cylindrical wall of the tube 70′. The upper section 134 is threadedly connected to the lower section 132. The upper end 136 of the upper section 134 passes through an opening in the top part 138 of the tube 70′ and can receive a handle (not shown) in a manner similar to that described above. The embodiment also provides a circuitous path, including gaps 94 and 95, through which material must flow to reach the opening 62 in the bowl bottom wall.

Still other variations are possible.

What is claimed is:

1. A food processing machine, comprising:
a mixer body including a stand and a bowl support pivotally mounted on the stand for selective pivot about a horizontal axis;
a bowl mounted atop the bowl support for pivot with the bowl support, the bowl including a bottom wall with an opening therein;
a tubular member connected to the bowl and extending upward from the opening and within the bowl, the tubular member including a lower end and an upper end, the lower end in a stationary sealed arrangement with the bottom wall of the bowl, the stationary sealed arrangement extending around the opening;
a drive mounted below the bowl support for pivot with the bowl support, the drive including a rotatable food processing component drive shaft extending upward through the opening of the bottom wall of the bowl and upward through the tubular member, wherein the rotatable food processing component drive shaft includes an upper end above an upper end of the tubular member.

2. The food processing machine of claim 1,
wherein the bowl includes an upper edge, wherein a bowl height is defined by a linear distance from the opening to a height of the upper edge,
wherein a tube height is defined by a linear distance from the opening to a height of the upper end of tubular member, wherein the tube height is at least thirty percent of the bowl height,
wherein a drive shaft height is defined by a linear distance from the opening to a height of the upper end of the drive shaft, wherein the drive shaft height is greater than the tube height and less than the bowl height.

3. The food processing machine of claim 2, wherein the tube height is at least fifty percent of the bowl height.

4. The food processing machine of claim 2, wherein the tube height is at least sixty-five percent of the bowl height.

5. The food processing machine of claim 1, wherein the tubular member is removably connected to the bowl.

6. The food processing machine of claim 5, wherein the tubular member includes a bottom flange that sealingly seats against a periphery of the opening in the bottom wall of the bowl.

7. The food processing machine of claim 5 wherein the tubular member includes a rotational connection to the bowl.

8. The food processing machine of claim 7 wherein the tubular member includes a twist fit/lock connection to the bowl.

9. The food processing machine of claim 5, wherein a bottom portion of the tubular member threadedly engages with a corresponding threaded portion at the bowl bottom for removable connection to the bowl.

10. The food processing machine of claim 9, wherein the corresponding threaded portion is formed on a mount hub that is secured to the bottom of the bowl.

11. The food processing machine of claim 10, wherein a sealing gasket is sandwiched between a lower surface portion of the mount hub and an upper surface portion of the bottom of the bowl.

12. The food processing machine of claim 11, wherein a sealing member is compressed between the bottom portion of the tubular member and the mount hub.

13. The food processing machine of claim 1, including a food processing attachment engaged on the upper end of the drive shaft, the food processing attachment including a tubular wall that extends downward alongside an outer surface of the tubular member.

14. The food processing machine of claim 13, wherein, in order for fluid to exit the bowl through the opening in the bottom wall, the fluid must pass upward along a gap between the inner surface of the tubular wall and the outer surface of the tubular member, and then downward through the tubular member to the opening.

15. The food processing machine of claim 13, wherein an upper end of the drive shaft is threaded, the food processing attachment is disposed over the upper end of the drive shaft with the upper end of the drive shaft extending above a top of the food processing attachment, and a handle member is threadedly engaged to the upper end of the drive shaft to retain the food processing attachment on the drive shaft.

16. A food processing machine, comprising:
a mixer body including a stand and a bowl support;
a bowl mounted atop the bowl support, the bowl including a bottom wall with an opening therein, the bowl having an upper edge, wherein a bowl height is defined by a linear distance from the opening to a height of the upper edge;
a tubular member formed separate from the bowl and connected to the bowl, the tubular member extending upward from the opening and within the bowl, the tubular member including a lower end and an upper end, wherein a tube height is defined by a linear distance from the opening to a height of the upper end of tubular member, wherein the tube height is less than the bowl height;
a drive mounted below the bowl support, the drive including a rotatable drive shaft extending upward through the opening of the bottom wall of the bowl and upward through the tubular member, the rotatable drive shaft including an upper end, wherein a drive shaft height is defined by a linear distance from the opening to a height of the upper end, wherein the drive shaft height is greater than the tube height and less than the bowl height.

17. The food processing machine of claim 16, including a food processing attachment engaged on the upper end of drive shaft, the food processing attachment including a tubular wall that extends downward alongside an outer surface of the tubular member.

18. The food processing machine of claim 17 wherein, in order for fluid in the bowl to exit the bowl through the opening in the bottom wall, the fluid must pass upward along a gap between the inner surface of the tubular wall and the outer surface of the tubular member, and then downward through the tubular member to the opening.

19. The food processing machine of claim 17 wherein an upper end of the drive shaft is threaded, the food processing attachment is disposed over the upper end of the drive shaft with the upper end of the drive shaft extending above a top of the food processing attachment, and a handle member is threadedly engaged to the upper end of the drive shaft to retain the food processing attachment on the drive shaft.

20. The food processing machine of claim 17 wherein the tubular member is removably connected to the bowl by a rotational connection that is one of a threaded connection or a twist fit/lock connection.
